(19) United States
(12) Patent Application Publication
(10) Pub. No.: US 2025/0027607 A1
(43) Pub. Date: Jan. 23, 2025

(54) TANK FOR STORING GAS

(71) Applicants: ARKEMA FRANCE, COLOMBES (FR); COVESS, Hasselt (BE)

(72) Inventors: Gilles HOCHSTETTER, Colombes (FR); Thibaut SAVART, Lacq (FR); Arthur BABEAU, Lacq (FR); Axel SALINIER, Lacq (FR); Tony VANSWIJGENHOVEN, Hasselt (BE); Johan DE CLIPPELEIR, OUD-HEVERLEE (BE)

(73) Assignees: ARKEMA FRANCE, Colombes (FR); COVESS, Hasselt (BE)

(21) Appl. No.: 18/708,442

(22) PCT Filed: Nov. 8, 2022
(86) PCT No.: PCT/EP2022/081071

§ 371 Date: May 8, 2024

(30) Foreign Application Priority Data
Nov. 9, 2021 (EP) 21306566.7

(51) Int. Cl. F17C 1/16; B32B 5/28; B32B 27/12; B32B 27/34

(52) U.S. Cl. CPC F17C 1/16; B32B 5/28; B32B 27/12; B32B 27/34; B32B 2250/03; B32B 2377/00; F17C 2203/066; F17C 2203/0675; F17C 2209/221; F17C 2209/23

(57) ABSTRACT

A tank comprising a multi-layer structure, for storing compressed gas, including in succession from inside to outside at least the three following layers: at least one sealing layer of a composition including at least one semi-crystalline thermoplastic polyamide having a Tm of less than or equal to 280° C., at least one intermediate composite reinforcing layer of a fibrous material in the form of continuous fibres impregnated with a composition including at least one semi-crystalline thermoplastic polyamide having a Tg of less than 100° C., at least one outer composite reinforcing layer of a fibrous material in the form of continuous fibres impregnated with a composition including at least one polyphthalamide having a Tg of greater than 80° C., the outermost sealing layer being welded to the innermost intermediate composite reinforcing layer and the outermost intermediate composite reinforcing layer being welded to the innermost outer composite reinforcing layer.

The invention relates to a tank comprising a specific multilayer structure for storing gas, in particular compressed gas at high pressure, and to the manufacturing method thereof.

One of the aims sought in the field of transport, and in particular in the automotive field, is to propose vehicles that are less and less polluting. Thereby, electric or hybrid vehicles including a battery aim to gradually replace internal combustion engine vehicles, such as gasoline or diesel vehicles. However, it turns out that the battery is a relatively complex constituent of the vehicle. Depending on the location of the battery in the vehicle, it may be necessary to protect same from shocks and from the external environment, which may be at extreme temperatures and at a variable humidity. It is also necessary to prevent any risk of flames.

In addition, it is important that the operating temperature of the vehicle does not exceed 55° C. in order not to damage the battery cells and preserve the service life thereof. Conversely, e.g. during winter time, it may be necessary to raise the temperature of the battery in order to optimize the operation thereof.

Moreover, the electric vehicle still suffers from several problems, namely the autonomy of the battery, the use of rare earth in the batteries, the resources of which are not inexhaustible, as well as a problem of production of electricity in different countries, so as to be able to recharge the batteries.

Hydrogen is thus an alternative to the electric battery, since hydrogen can be transformed into electricity by means of a fuel cell and thereby power electric vehicles.

Nevertheless, hydrogen storage is technically difficult and expensive due to the very low molecular weight and the very low liquefaction temperature of hydrogen, especially when it comes to mobile storage. However, to be effective, storage should take place in small volumes, which requires the hydrogen to be kept under high pressure, taking into account the temperatures at which vehicles are used. This is the case, in particular, for fuel cell hybrid road vehicles for which an autonomy on the order of 600 to 700 km is sought, or even less for essentially urban uses, as a complement to a battery-powered electrical base.

Hydrogen tanks generally consist of a metal liner, which should prevent the diffusion of hydrogen outside the shell. The first shell should be as such protected by a second casing (generally made of composite materials) intended to withstand the internal pressure of the tank (e.g. 700 bars) and resistant to possible shocks or sources of heat. Moreover, the tank includes a valve system, which should also be safe.

According to the Memorandum on Hydrogen of the French Association for Hydrogen and fuel cell (AFHYPAC (Association Française pour l'hydrogène et la pile à combustible)) Sheet 4.2, revision of December 2016, the storage and dispensing of hydrogen under pressure has been a standard practice for many years, with cylinders or cylinder assemblies, made of steel, pressurized to 20 or 25 MPa (types I and II). The disadvantage of such way of storage is the bulk—only 14 kg/m3 at 20 MPa and at ordinary temperature (21° C.) versus 100 kg/m3 for methane—and especially the weight, which results from the use of steels with low stress levels in order to avoid the problems of embrittlement caused by hydrogen. The situation has changed radically with the advent of the technology of so-called type III and IV composite tanks. The basic principle of said tanks is to separate the two essential functions which are the sealing and the mechanical resistance in order to manage one independently of the other. In said type of tank, a bladder made of (thermosetting or thermoplastic) resin called a sealing liner or sheath is associated with a reinforcing structure consisting of fibers (glass, aramid, carbon) called a reinforcing sheath or layer. Said type of tank makes it possible to work at much higher pressures while reducing the mass of the tank and preventing the risk of explosive rupture in the event of severe external aggressions. Thereby, a pressure of 70 MPa (700 bar) has become practically the current standard.

In type IV tanks, the sealing layer and the reinforcing layer are made of different materials, which do not adhere to each other, often responsible for the collapse of the sealing layer, whenever, simultaneously, there is both an accumulation of gas at the interface between the sealing layer and the reinforcing layer and a decrease in the internal pressure of the tank. Furthermore, the drying of type IV tanks, which takes place after the water pressure test, takes long and is expensive, as drying can only take place under vacuum due to the risk of collapse of the sealing layer.

Such problem has given rise to the development of type V tanks, which are based on the use of the same polymer for the sealing layer and for the matrix of the reinforcing layer, in order to provide excellent and durable weldability between the two layers, thereby being used for obtaining a one-piece tank.

To produce the composite shell, it is known how to use epoxy resins as matrix of the composite, for manufacturing tanks which can have a high glass transition temperature (hereinafter Tg), i.e. a Tg greater than 100° C. The disadvantage of the composites containing thermosetting resins, in particular epoxy resins, is that same are generally microcracked, which causes great variability or even a loss of mechanical strength. Moreover, such phenomenon is amplified over time with the successive filling/emptying cycles of the tanks. It is thus necessary to increase the carbon fiber content and hence the weight and cost of the tank.

Furthermore, in the case of thermosetting resins, in particular epoxy resins, microcracking adversely affects the impermeability of the composite reinforcement, which requires the use of a thick sealing layer inside the tank (i.e. a type IV tank).

Finally, in terms of recyclability, current tanks use reinforcing layers made of thermosetting resins, in particular epoxy resins, which are not recyclable.

However, despite the improvements made to type IV tanks, same still have drawbacks. In particular, it is sought to accelerate the filling speed of the tank. Yet, the temperature resistance of gas tanks, in particular hydrogen tanks, is too low with current solutions. Accelerating the filling speed of the tank would be an advantage, in particular cost-saving for the consumer, in particular without having, in addition, to cool the hydrogen to −60° C. before filling.

The use of a polyphthalamide reinforcing layer (hereinafter referred to as PPA) with a high glass transition temperature (hereinafter Tg) would be an important advantage in terms of mechanical resistance at high temperatures. Furthermore, said type of resin being thermoplastic, same would serve to obtain an easily recyclable tank. The thermoplastic nature of the resin would reduce the level of microcracking of the composite shell, thereby reinforcing the mechanical resistance thereof and reducing the variability of the mechanical resistance, which would significantly reduce the amount of carbon fibers used and hence the cost and the carbon footprint of the type V tank compared to same of a type IV tank. Furthermore, the semi-crystalline nature of the resin would increase the sealing to gases, and in particular to hydrogen. Therefore, the composite shell would contribute to the impermeability of the tank and thereby reduce the thickness of the sealing layer and hence the cost and the weight of the inner sealing layer of the tank.

However, the manufacture of such type of tank by winding hot composite tapes on a thermoplastic polymer sealing layer, raises difficulties, linked to the occurrence of significant residual stresses of thermal origin, inherent in the differential expansions of the materials involved, more particularly inherent in the differential expansions between the fibers and the polymer composing the sealing layer, during the cooling of the tank, at the end of the manufacture thereof. The above is particularly exacerbated in the case of a PPA matrix composing the carbon fiber composite reinforcement. Indeed, the high temperature for using the composite tape containing PPA, due to the high melting point of such type of resin, as well as the high Tg thereof, are the major sources responsible for the additional residual stresses in the tank. When the tank includes molded inserts of polyamide resin with low Tg, typically a Tg on the order of 50° C., more particularly of polyamide 11 (PA11), said residual stresses may lead to a deformation of the inserts, preventing the complete manufacture of the tank and in particular the fastening of the bases closing the tank. When the tank is a type V (or 4.5, i.e. the polymer composing the matrix of the composite is of a different nature from the polymer of the sealing layer, but the two polymers remain compatible and weldable to each other) and same has a polyamide sealing layer with a low Tg, more particularly of the type PA11, the residual stresses may lead to a decohesion within the composite reinforcing layer as such.

Therefore, tanks that have a good mechanical resistance at high temperature, can be recycled, have good gas sealing, and are easy to manufacture, are currently sought. In particular, a tank structure is sought, which reduces the level of residual mechanical stresses between the composite and the sealing layer and between the composite and the molded inserts, relating to the thermal differences experienced by the tank during the manufacture thereof. Such tanks would thereby serve to store hydrogen and also any type of gas under pressure, and in particular under high pressure.

Such problem is solved by a tank including a particular multilayer structure.

The invention relates to a tank comprising a multilayer structure, for storing compressed gas, preferentially under high pressure, more particularly hydrogen, comprising at least the following three successive layers, from the inside to the outside:
at least one sealing layer consisting of a composition comprising on a majority basis at least one semi-crystalline thermoplastic polyamide, preferentially aliphatic, having a melting temperature (Tf), measured according to the standard ISO 11357-3:2013, less than or equal to 280° C., preferentially less than or equal to 260° C., preferentially less than or equal to 230° C., and more particularly less than or equal to 200° C.,
at least one intermediate composite reinforcing layer consisting of a fibrous material in the form of continuous fibers impregnated with a composition comprising on a majority basis at least one semi-crystalline thermoplastic polyamide, preferentially aliphatic, having a Tg measured according to the standard ISO 11357-3:2013, less than 100° C., preferentially less than or equal to 80° C., more particularly less than or equal to 60° C.,
at least one outer composite reinforcing layer consisting of a fibrous material in the form of continuous fibers impregnated with a composition comprising on a majority basis at least one polyphthalamide having a Tg, measured according to the standard ISO 11357-3:2013, greater than 80° C., preferentially greater than 100° C.,
the outermost sealing layer being welded to the innermost intermediate composite reinforcing layer and
the outermost intermediate composite reinforcing layer being welded to the innermost outer composite reinforcing layer.

The inventors have found that by inserting a composite reinforcing layer of semi-crystalline thermoplastic polyamide, preferentially aliphatic, with Tg<100° C., between a specific sealing layer and a specific composite reinforcing layer made of PPA, the problems mentioned hereinabove were solved.

Indeed, the tank according to the invention is easy to manufacture, same permits a quick filling and emptying. The tank has high gas sealing and is characterized by a low weight.

The invention further relates to a manufacturing method for a tank according to the invention.

Finally, the invention relates to the use of the tank according to the invention for the storage of gas under pressure, more particularly hydrogen, LPG or CNG, compressed air.

Other features, aspects, objects and advantages of the present invention will become even clearer upon reading the following description.

Moreover, it is specified that the expressions “comprised between . . . and . . . ” and “from . . . to . . . ” used in the present description should be understood as including each of the boundaries mentioned.

### The Tank

The tank according to the invention comprises a multilayer structure, for the storage of compressed gas, more particularly hydrogen, comprising at least the following three successive layers, from the inside to the outside:
at least one sealing layer consisting of a composition comprising on a majority basis at least one semi-crystalline thermoplastic polyamide, preferentially aliphatic, having a Tf, measured according to the standard ISO 11357-3:2013, less than or equal to 280° C., preferentially less than or equal to 260° C., preferentially less than or equal to 230° C., and more particularly less than or equal to 200° C.,
at least one intermediate composite reinforcing layer consisting of a fibrous material in the form of continuous fibers impregnated with a composition comprising on a majority basis at least one semi-crystalline thermoplastic polyamide, preferentially aliphatic, having a Tg measured according to the standard ISO 11357-3:2013, less than 100° C., preferentially less than or equal to 80° C., more particularly less than or equal to 60° C.,
at least one outer composite reinforcing layer consisting of a fibrous material in the form of continuous fibers impregnated with a composition comprising on a majority basis at least one polyphthalamide having a Tg, measured according to the standard ISO 11357-3:2013, greater than 80° C., preferentially greater than or equal to 100° C.,
the outermost sealing layer being welded to the innermost intermediate composite reinforcing layer and
the outermost intermediate composite reinforcing layer being welded to the innermost composite reinforcing layer.

The layers of the structure according to the invention all include, on a majority basis, a polyamide.

The nomenclature used to define polyamides is described in the standard ISO 1874-1:2011 “Plastics—Polyamide (PA) molding and extrusion materials—Part 1: Description”, in particular on page 3 (Tables 1 and 2) and is well known to a person skilled in the art. In the PAL notation, PA denotes polyamide and L denotes the number of carbon atoms of the amino acid or of the lactam. Thereby, the polyamide is obtained by polycondensation of the amino acid or of the lactam including L carbon atoms. In the PAMN notation, M denotes the number of carbon atoms of the diamine and N denotes the number of carbon atoms of the diacid.

According to the invention, “semi-crystalline thermoplastic polyamide” means a material that is generally solid at room temperature and softens when the temperature increases, more particularly after exceeding the glass transition temperature (Tg), and can exhibit a clear melting when exceeding the so-called melting temperature (Tf) thereof, and which becomes solid again when the temperature decreases below the crystallization temperature (TC) thereof.

The glass transition temperature Tg, the crystallization temperature TC and the melting temperature Tf are determined by differential scanning calorimetry (DSC) according to standard 11357-2:2013 and 11357-3:2013, respectively.

### As Regards the Sealing Layer

One or a plurality of sealing layers is or may be present in the multilayer structure of the tank according to the invention.

Each of said layers consists of a composition comprising on a majority basis at least one semi-crystalline thermoplastic polyamide having a Tf, measured according to the standard ISO 11357-3:2013, less than or equal to 280° C., preferentially less than or equal to 260° C., preferentially less than or equal to 230° C., and more particularly less than or equal to 200° C.

The term “on a majority basis” means that said at least one polyamide is present in an amount of more than 50% by weight relative to the total weight of the composition.

Advantageously, said at least one majority polyamide is present in an amount of more than 60% by weight, in particular in an amount of more than 70% by weight, particularly in an amount of more than 80% by weight, more particularly greater than or equal to 90% by weight, relative to the total weight of the composition.

The composition may also comprise impact modifiers and/or additives. However, the barrier layer should not release harmful compounds into the stored gas, nor comprise particles likely to reduce the permeability thereof. Thereby, a person skilled in the art would take care to choose the additives of the composition, as well as the content thereof, so as to prevent such release.

Additives can be selected from among an antioxidant, a heat stabilizer, an UV absorber, a light stabilizer, a lubricant, an inorganic filler, a flame retardant, a nucleating agent, a plasticizer, a dye, carbon black and carbonaceous nanofillers.

Advantageously, said composition consists on a majority basis of one or a plurality of semi-crystalline thermoplastic polyamides defined hereinabove, from 0 to 5% by weight of impact modifier, from 0 to 5% by weight of additives, the sum of the constituents of the composition being equal, by weight, to 100%.

In one embodiment of the tank according to the invention, a single majority polyamide is present in the sealing layer.

Advantageously, the composition forming the sealing layer is black and can absorb a radiation suitable for welding.

In order to make same absorbent, it is known how to add various additives thereto, including e.g. carbon black, which imparts to the polymer a black color and lead to a better absorption of a radiation suitable for welding.

### Semi-Crystalline Thermoplastic Polyamide

The semi-crystalline thermoplastic polyamide may be a homopolyamide or a copolyamide.

Advantageously, the semi-crystalline thermoplastic polyamide comprised in the sealing layer has a ratio between the number of carbon atoms and the number of nitrogen atoms in the polyamide noted C/N, greater than or equal to 5, preferentially greater than or equal to 8, particularly greater than or equal to 9, and more particularly greater than or equal to 10.

Preferentially, the semi-crystalline thermoplastic polyamide is chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11 and PA12, preferentially PA410, PA510, PA 69, PA610, PA 512, PA612, PA 514, PA614, PA618, PA PA1010, PA1012, PA1014, PA1018, PA1214, PA1218, PA11 and PA12, PA 11/5T, PA 11/6T and PA11/10T, very preferentially PA 11 or PA12, and mixtures thereof.

The content of unit 11 in the semi-aromatic copolyamides is adjusted so that the copolyamide has a melting point of less than or equal to 280° C., preferentially less than or equal to 260° C., preferentially less than or equal to 230° C., and more particularly less than or equal to 200° C.

In a preferred embodiment, the semi-crystalline thermoplastic polyamide is an aliphatic semi-crystalline thermoplastic polyamide.

Preferentially, the semi-crystalline thermoplastic polyamide comprised in the sealing layer is an aliphatic semi-crystalline thermoplastic polyamide, more particularly chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11 AND PA12, preferentially PA6, PA66, PA410, PA510, PA 69, PA610, PA 512, PA612, PA 514, PA614, PA618, PA PA1010, PA1012, PA1014, PA1018, PA1214, PA1218, PA11 and PA12, very preferentially PA 11 or PA12, and mixtures thereof.

More particularly, the aliphatic semi-crystalline thermoplastic polyamide is chosen from among polyamide 11 (PA11), polyamide 12 (PA12), polyamide 1010 (PA1010), polyamide 1012 (PA1012), more particularly PA11 and PA12.

The composition forming the sealing layer comprises on a majority basis a polyamide as defined hereinabove, or a mixture of the polyamides defined hereinabove. Such mixture is present in the composition on a majority basis.

### As Regards the Intermediate Composite Reinforcing Layer

One or a plurality of composite reinforcing layers is or may be present as an intermediate layer.

Each of said layers consists of a fibrous material in the form of continuous fibers impregnated with a composition comprising on a majority basis at least one semi-crystalline thermoplastic polyamide, preferentially aliphatic, having a Tg measured according to the standard ISO 11357-3:2013, less than 100° C., preferentially less than or equal to 80° C., more particularly less than or equal to 60° C.

The term “on a majority basis” means that said at least one polymer is present in an amount of more than 50% by weight relative to the total weight of the composition.

Advantageously, said at least one majority polymer is present in an amount of more than 60% by weight, in particular in an amount of more than 70% by weight, particularly in an amount of more than 80% by weight, more particularly greater than or equal to 90% by weight, relative to the total weight of the composition.

The composition may also comprise impact modifiers and/or additives.

Additives can be selected from among an antioxidant, a heat stabilizer, an UV absorber, a light stabilizer, a lubricant, an inorganic filler, a flame retardant, a nucleating agent, a plasticizer, a dye, carbon black and carbonaceous nanofillers.

Advantageously, said composition consists on a majority basis of one or a plurality of semi-crystalline thermoplastic polyamides defined hereinabove, from 0 to 5% by weight of impact modifier, from 0 to 5% by weight of additives, the sum of the constituents of the composition being equal, by weight, to 100%.

In one embodiment of the tank according to the invention, a single majority polyamide is present in the layer impregnating the fibrous material of the intermediate composite reinforcing layer.

Advantageously, the composition forming the layer in the layer impregnating the fibrous material of the intermediate composite reinforcing layer is black and can absorb a radiation suitable for welding.

In order to make same absorbent, it is known how to add various additives thereto, including e.g. carbon black, which imparts a black color to the polymer and leads to a better absorption of a radiation suitable for welding.

### Semi-Crystalline Thermoplastic Polyamide

The aliphatic semi-crystalline thermoplastic polyamide may be a homopolyamide or a copolyamide.

Preferentially, the semi-crystalline thermoplastic polyamide is chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11 AND PA12, preferentially PA410, PA510, PA 69, PA610, PA 512, PA612, PA 514, PA614, PA618, PA PA1010, PA1012, PA1014, PA1018, PA1214, PA1218, PA11 and PA12, PA 11/5T, PA 11/6T and PA11/10T, very preferentially PA 11 or PA12, and mixtures thereof.

The content of unit 11 in the semi-aromatic copolyamides is adjusted so that the copolyamide has a glass transition temperature of less than 100° C., preferentially less than or equal to 80° C., more particularly less than or equal to 60° C.

In a preferred embodiment, the semi-crystalline thermoplastic polyamide is an aliphatic semi-crystalline thermoplastic polyamide

Advantageously, the aliphatic semi-crystalline thermoplastic polyamide comprised in the composition, which impregnates the fibrous material, is chosen from PA410, PA 56, PA59, PA510, PA512, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11 AND PA12, preferentially PA6, PA66, PA410, PA510, PA 69, PA610, PA 512, PA612, PA 514, PA614, PA618, PA PA1010, PA1012, PA1014, PA1018, PA1214, PA1218, PA11 and PA12, and mixtures thereof.

More particularly, the aliphatic semi-crystalline thermoplastic polyamide is chosen from among polyamide 11 (PA11), polyamide 12 (PA12), polyamide 1010 (PA1010), polyamide 1012 (PA1012), more particularly PA11 and PA12.

### As Regards the Outer Composite Reinforcing Layer

One or a plurality of composite reinforcing layers may be present as an outer layer.

Each of said layers consists of a composition comprising on a majority basis at least one polyphthalamide having a Tg, measured according to the standard ISO 11357-3:2013, greater than 80° C., preferentially greater than or equal to 100° C.

The term “on a majority basis” means that said at least one polymer is present in an amount of more than 50% by weight relative to the total weight of the composition.

Advantageously, said at least one majority polymer is present in an amount of more than 60% by weight, in particular in an amount of more than 70% by weight, particularly in an amount of more than 80% by weight, more particularly greater than or equal to 90% by weight, relative to the total weight of the composition,

The composition may also comprise impact modifiers and/or additives.

Additives can be selected from among an antioxidant, a heat stabilizer, an UV absorber, a light stabilizer, a lubricant, an inorganic filler, a flame retardant, a nucleating agent, a plasticizer, a dye, carbon black and carbonaceous nanofillers.

Advantageously, said composition consists on a majority basis of one or a plurality of semi-crystalline thermoplastic polyamides defined hereinabove, from 0 to 5% by weight of impact modifier, from 0 to 5% by weight of additives, the sum of the constituents of the composition being equal, by weight, to 100%.

In one embodiment of the tank according to the invention, a single majority polyamide is present in the layer in the layer impregnating the fibrous material of the outer composite reinforcing layer.

Advantageously, the composition is black and can absorb a radiation suitable for welding.

In order to make same absorbent, it is known how to add various additives thereto, including e.g. carbon black, which imparts to the polymer a black color and lead to a better absorption of a radiation suitable for welding.

### Polyphthalamide

The polyamide may be a homopolyamide or a copolyamide.

Advantageously, the semi-crystalline polyamides are semi-aromatic polyamides, in particular a semi-aromatic polyamide with the formula X/YAr, as described in EP1505099, in particular a semi-aromatic polyamide with the formula A/XT in which A is chosen from a unit obtained from an amino acid, a unit obtained from a lactam and a unit with the formula (Ca diamine). (Cb diacid), with a being the number of carbon atoms of the diamine and b being the number of carbon atoms of the diacid, a and b each being comprised between 4 and 36, advantageously between 9 and 18, the unit (Ca diamine) being chosen from linear or branched aliphatic diamines, cycloaliphatic diamines and alkylaromatic diamines and the unit (Cb diacid) being chosen from linear or branched aliphatic diacids, cycloaliphatic diacids and aromatic diacids;

X.T denotes a unit obtained from the polycondensation of a Cx diamine and terephthalic acid, with x representing the number of carbon atoms of the Cx diamine, x being comprised between 5 and 36, advantageously between 9 and 18.

Preferentially, the polyamide comprised in the layer impregnating the fibrous material of the outer composite reinforcing layer has the formula A/5T, A/6T, A/9T, A/10T, A/11T, a/BACT, A/MPMDT or A/MXDT, A being as defined herein, more particularly a copolyamide chosen from a PA MPMDT/6T, PA 11/10T, PA 5T/10T, PA 11/6T/10T, PA MXDT/4T, PA MXDT/6T PA, MXDT/10T PA, MPMDT/4T PA, MPMDT/6T PA, MPMDT/10T PA, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PAII/5T/10T, PA 11/BACT, PA BACT/10T, PA BACT/6T, PA BACT/4T, PA BACT/10T/6T, PA 11/BACT/4T, PA 11/BACT/6T, PA 11/BACT/10T and mixtures thereof.

T stands for terephthalic acid, MXD stands for m-xylylene diamine, MPMD stands for 2-methylpentamethyenediamine and BAC stands for bis(aminomethyl)cyclohexane.

The composition may also comprise impact modifiers and/or additives.

Additives can be selected from among an antioxidant, a heat stabilizer, an UV absorber, a light stabilizer, a lubricant, an inorganic filler, a flame retardant, a nucleating agent, a plasticizer, and a coloring agent.

Advantageously, said composition consists of one or a plurality of polyphthalamides having a Tg, measured according to the standard ISO 11357-3:2013, greater than 80° C., from 0 to 5% by weight of impact modifier, from 0 to 5% by weight of additives, the sum of the constituents of the composition being equal to 100%.

Said at least one majority polymer of each layer may be identical or different.

In one embodiment, a single polyphthalamide is present on a majority basis in the outer composite reinforcing layer welded to the intermediate layer.

Advantageously, the carbonaceous nanofillers are non-agglomerated or non-aggregated.

Advantageously, the carbonaceous nanofillers are incorporated into the composition in an amount of from 100 ppm to 500 ppm, and preferentially from 100 ppm to 250 ppm.

Advantageously, the carbonaceous nanofillers are chosen from carbon nanotubes (CNTs), carbon nanofibers, graphene, nanometric carbon black, and mixtures thereof.

Advantageously, the carbonaceous nanofillers are devoid of nanometric carbon black.

### As Regards to the Fibrous Material

With regard to the fibers forming said fibrous material present in the intermediate and outer layers same are in particular fibers of mineral, organic or plant origin.

Advantageously, said fibrous material may be sized or unsized.

Said fibrous material may thus comprise up to 0.1% by weight of a material of organic nature (thermosetting or thermoplastic resin) called sizing.

Fibers of mineral origin include e.g. carbon fibers, glass fibers, basalt or basalt-based fibers, silica fibers or silicon carbide fibers.

Fibers of organic origin include e.g. fibers based on thermoplastic or thermosetting polymer, such as semi-aromatic polyamide fibers, aramid fibers or polyolefin fibers. Preferentially, same contain an amorphous thermoplastic polymer and have a glass transition temperature Tg greater than the Tg of the constituent thermoplastic polymer or polymer mixture of the pre-impregnation matrix when the latter is amorphous, or greater than the Tf of the constituent thermoplastic polymer or polymer mixture of the pre-impregnation matrix when the latter is semi-crystalline. Advantageously, same contain a semi-crystalline thermoplastic polymer and have a melting temperature Tf greater than the Tg of the constituent thermoplastic polymer or polymer mixture of the pre-impregnation matrix when the latter is amorphous, or greater than the Tf of the constituent thermoplastic polymer or polymer mixture of the pre-impregnation matrix when the latter is semi-crystalline. Thus, there is no risk of melting for the organic fibers of the fibrous material when the final composite is impregnated by the thermoplastic matrix.

Fibers of plant origin include natural fibers containing flax, hemp, lignin, bamboo, silk, in particular spider silk, sisal, and other cellulosic fibers, more particularly viscose. The fibers of plant origin can be used pure, treated or coated with a coating layer, in order to facilitate the adhesion and the impregnation of the thermoplastic polymer matrix.

The fibrous material may also be a fabric, braided or woven with fibers.

Same may also correspond to fibers with holding threads.

Such constituent fibers can be used alone or in a mixture. Thereby, organic fibers can be mixed with the mineral fibers to be pre-impregnated with thermoplastic polymer powder and form the pre-impregnated fibrous material.

The yarns of organic fibers may have a plurality fabric weights. Furthermore, same may also have a plurality of geometries. The constituent fibers of the fibrous material may also be in the form of a mixture of the reinforcing fibers with different geometries. Fibers are continuous fibers.

Preferentially, the fibrous material consists of continuous fibers chosen from glass fibers, carbon fibers, basalt fibers or fibers containing basalt, more particularly carbon fibers. Same is used in the form of a yarn or of a plurality of yarns.

### As Regards the Multilayer Structure

Said multilayer structure thus comprises at least one sealing layer, at least one intermediate composite reinforcing layer and at least one outer composite reinforcing layer. The layers, which are adjacent to each other, are all welded to each other.

In one embodiment, in said multilayer structure, each polyamide comprised in the composition forming each sealing layer is partially or totally miscible with each polyamide comprised in the composition each forming sealing layer, which is adjacent thereto.

The same applies to intermediate composite reinforcing layers, when the structure comprises a plurality of layers.

The same is true for the outer composite reinforcing layers, when the structure comprises a plurality of layers.

In addition, the outermost sealing layer is welded to the innermost intermediate composite reinforcing layer and the outermost intermediate composite reinforcing layer is welded to the innermost outer composite reinforcing layer.

Such welding of the various layers leads to total or partial miscibility of the compositions and/or of the matrices comprised in the layers.

The total or partial miscibility of said compositions is defined by the compound ratio between the difference in the glass transition temperatures of the two compositions of two adjacent layers, and the difference in the glass transition temperatures of the two compositions, prior to the mixing by welding of the two compositions.

The miscibility is total when said ratio is equal to 0, and partial when said ratio is different from 0 and less than 1, in absolute value. An immiscibility of the polyamide comprised in the composition forming the sealing layer with the polyamide comprised in the composition impregnating the fibrous material of the intermediate layer, is excluded. Similarly, an immiscibility of the polyamide comprised in the composition which impregnates the fibrous material of the intermediate layer with the polyamide in the composition which impregnates the fibrous material of the outer layer, is excluded.

Advantageously, when the miscibility of said compositions is partial, said ratio is less than 30%, preferentially less than 20%, in absolute value.

In one embodiment, the glass transition temperature or temperatures of the mixture, depending on whether the miscibility is total or partial, should be comprised between the glass transition temperatures of said polyamides before mixing and different from same, by at least 5° C., preferentially by at least 10° C.

The expression “totally miscible” means that when e.g. two polyamides denoted PAa and PAb, having a Tga and a Tgb, respectively, are present in two adjacent sealing layers or reinforcing layers, respectively, and Tga is less than Tgb, then the mixture of the two polyamides has only one Tgab, the value of which is comprised between Tga and one Tgb.

The value Tgab value is then greater than Tga by at least 5° C., more particularly by at least 10° C., and less than Tgb by at least 5° C., more particularly by at least 10° C.

The expression “partially miscible” means that when e.g. two polyamides PAa and PAb, having a Tga and a Tgb, respectively, are present in two adjacent sealing layers or reinforcing layers, then the mixture of the two polyamides has two Tg, Tg′a and Tg′b, with Tga<Tg′a<Tg′b<Tgb.

The values Tg′a and Tg′b are then greater than Tga by at least 5° C., more particularly by at least 10° C., and lower than Tgb by at least 5° C., more particularly by at least 10° C.

An immiscibility of two polyamides results in the presence of two Tg, Tga and Tgb, in the mixture of the two polyamides which correspond to the respective Tg Tga and Tgb of the pure polymers taken separately.

If the glass transition temperatures in the mixture of the two polyamides were identical or different at the temperatures before mixing, but if the two polyamides were reactive with each other, said would not be outside the scope of the invention.

Advantageously, said welded sealing and intermediate reinforcing layers consist of compositions which comprise different polyamides, respectively, and said intermediate reinforcement and outer reinforcing layers consist of compositions which comprise different polyamides, respectively.

The multilayer structure may comprise up to 300 sealing layers, up to 10 intermediate composite reinforcing layers and up to 300 outer composite reinforcing layers.

It is quite obvious that said multilayer structure is not necessarily symmetrical and that same can thus comprise more sealing layers than composite layers or vice versa.

Advantageously, said multilayer structure comprises one, two, three, four, five, six, seven, eight, nine or ten sealing layers, one, two, three, four, five, six, seven, eight, nine or ten intermediate composite reinforcing layers and one, two, three, four, five, six, seven, eight, nine or ten outer composite reinforcing layers.

Advantageously, said multilayer structure comprises one, two, three, four or five sealing layers, one, two, three, four or five intermediate composite reinforcing layers and one, two, three, four or five outer composite reinforcing layers.

Advantageously, said multilayer structure comprises one, two or three sealing layers and one or three composite reinforcing layers. Advantageously, same consist of compositions which comprise different polyamides, respectively.

In a preferred embodiment, the tank according to the invention comprises a multilayer structure, which comprises only one sealing layer, only one intermediate composite reinforcing layer and only one outer composite reinforcing layer, said sealing layer being welded to said adjacent intermediate composite reinforcing layer and said intermediate composite reinforcing layer being welded to said adjacent outer composite reinforcing layer, said intermediate composite reinforcing layer preferentially having a thickness comprised between 1 and 30%, more particularly a thickness comprised between 1 and 10%, even more preferentially between comprised 1 and 5% relative to the thickness of all the composite reinforcing layers of the multilayer structure, i.e. the intermediate composite reinforcing layer(s) and the outer composite reinforcing layer(s).

In another embodiment, the tank according to the invention comprises a multilayer structure, which comprises only one sealing layer, only one intermediate composite reinforcing layer and only one outer composite reinforcing layer, said sealing layer being welded to said adjacent intermediate composite reinforcing layer and said intermediate composite reinforcing layer being welded to said adjacent outer composite reinforcing layer, the composition of said sealing layer being identical to the composition of said intermediate composite reinforcing layer and said intermediate composite reinforcing layer preferentially having a thickness comprised between 1 and 30%, more particularly a thickness comprised between 1 and 10%, even more preferentially comprised between 1 and 5% relative to the thickness of all the composite reinforcing layers of the multilayer structure.

In another preferred embodiment, the tank according to the invention comprises a multilayer structure, which comprises:
only one sealing layer consisting of a composition comprising on a majority basis at least one semi-crystalline thermoplastic polyamide, preferentially aliphatic, having a melting temperature (Tf), measured according to the standard ISO 11357-3:2013, less than or equal to 230° C.,
only one intermediate composite reinforcing layer consisting of a fibrous material in the form of continuous fibers impregnated with a composition comprising on a majority basis at least one semi-crystalline thermoplastic polyamide, preferentially aliphatic, having a Tg measured according to the standard ISO 11357-3:2013, below 60° C. and
only one outer composite reinforcing layer consisting of a fibrous material in the form of continuous fibers impregnated with a composition comprising on a majority basis at least one polyphthalamide having a Tg, measured according to the standard ISO 11357-3:2013, greater than 100° C.,
the sealing layer being welded to the intermediate composite reinforcing layer and the intermediate composite reinforcing layer being welded to the outer composite reinforcing layer.

According to a preferred embodiment, all the composite reinforcing layers contain carbon fibers.

According to a preferred embodiment, the tank according to the invention comprises a multilayer structure, for the storage of compressed gas, more particularly hydrogen, comprising at least the following three successive layers, from the inside to the outside:
At least one sealing layer consisting of a composition comprising on a majority basis at least one semi-crystalline thermoplastic polyamide having a Tf, measured according to the standard ISO 11357-3:2013, less than or equal to 280° C. and chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, PA 11/5T, PA 11/6T AND PA11/10T preferentially PA410, PA510, PA 69, PA610, PA 512, PA612, PA 514, PA614, PA618, PA PA1010, PA1012, PA1014, PA1018, PA1214, PA1218, PA11 and PA12, preferentially PA 11 or PA12, and mixtures thereof,
at least one intermediate composite reinforcing layer consisting of a fibrous material in the form of continuous fibers impregnated with a composition comprising on a majority basis at least one semi-crystalline thermoplastic polyamide, having a Tg measured according to the standard ISO 11357-3:2013, less than 100° C., preferentially less than or equal to 80° C., in particular less than or equal to 60° C., and chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, 25 PA1218, PA11, PA12, PA 11/5T, PA 11/6T AND PA11/10T preferentially PA6, PA66, PA410, PA510, PA 69, PA610, PA 512, PA612, PA 514, PA614, PA618, PA PA1010, PA1012, PA1014, PA1018, PA1214, PA1218, PA11 and PA12, preferentially PA 11 or PA12, and mixtures thereof,
at least one outer composite reinforcing layer consisting of a fibrous material in the form of continuous fibers impregnated with a composition comprising on a majority basis at least one polyphthalamide having a Tg, measured according to the standard ISO 11357-3:2013, greater than 80° C., preferentially greater than 100° C., chosen from PA MPMDT/6T, PA 11/10T, PA 11/BACT, PA 5T/10T, PA 11/6T/10T, MXDT/4T PA, MXDT/6T PA, MXDT/10T PA, PAMPMDT/4T PA, MPMDT/6T PA, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA11/MPMDT/4T, PA 11/MPMDT/6T, PA 11/MPMDT/10T, PA 11/MXDT/10T, PA11/5T/10T, and mixtures thereof,
the outermost sealing layer being welded to the innermost intermediate composite reinforcing layer and
the outermost intermediate composite reinforcing layer being welded to the innermost outer composite reinforcing layer.

According to a preferred embodiment, the tank according to the invention comprises a multilayer structure, for the storage of compressed gas, more particularly hydrogen, comprising at least the following three successive layers, from the inside to the outside:
at least one sealing layer consisting of a composition comprising on a majority basis at least one semi-crystalline thermoplastic aliphatic polyamide having a Tf, measured according to the standard ISO 11357-3:2013, less than or equal to 280° C. and chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, preferentially PA 6, PA66, PA410, PA510, PA 69, PA610, PA 512, PA612, PA 514, PA614, PA618, PA PA1010, PA1012, PA1014, PA1018, PA1214, PA1218, PA11 and PA12, preferentially PA 11 or PA12, and mixtures thereof,
at least one intermediate composite reinforcing layer consisting of a fibrous material in the form of continuous fibers impregnated with a composition comprising on a majority basis at least one semi-crystalline thermoplastic aliphatic polyamide having a Tg measured according to the standard ISO 11357-3:2013, less than 100° C., preferentially less than or equal to 80° C., in particular less than or equal to 60° C., and chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11, PA12 preferentially PA 6, PA66, PA410, PA510, PA 69, PA610, PA 512, PA612, PA 514, PA614, PA618, PA PA1010, PA1012, PA1014, PA1018, PA1214, PA1218, PA11 and PA12, preferentially PA 11 or PA12, and mixtures thereof,
at least one outer composite reinforcing layer consisting of a fibrous material in the form of continuous fibers impregnated with a composition comprising on a majority basis at least one polyphthalamide having a Tg, measured according to the standard ISO 11357-3:2013, greater than 80° C., preferentially greater than 100° C., chosen from PA MPMDT/6T, PA 11/10T, PA 11/BACT, PA 5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T,
PA 11/BACT/4T, PA 11/BACT/6T, PA 11/BACT/10T, PA 11/MXDT/4T, PA 11/MXDT/6T, PA 11/MXDT/10T, PA11/MPMDT/4T, PA 11/MPMDT/6T, PA 11/MPMDT/10T, PA 11/MXDT/10T,
PA11/5T/10T, and mixtures thereof,
the outermost sealing layer being welded to the innermost intermediate composite reinforcing layer and
the outermost intermediate composite reinforcing layer being welded to the innermost outer composite reinforcing layer.

In another preferred embodiment, the tank according to the invention comprises a multilayer structure, which comprises
only one sealing layer of polyamide 6,
only one intermediate composite reinforcing layer, the matrix of which is of polyamide 6 and
only one outer composite reinforcing layer, the matrix of which is a copolyamide comprising a BACT unit, i.e. with the formula A/BACT,
the sealing layer being welded to the intermediate composite reinforcing layer and the intermediate composite reinforcing layer being welded to the outer composite reinforcing layer.

In another preferred embodiment, the tank according to the invention comprises a multilayer structure, which comprises
only one sealing layer of polyamide 66,
only one intermediate composite reinforcing layer the matrix of which is of polyamide 66 and
only one outer composite reinforcing layer, the matrix of which is a copolyamide comprising a BACT unit, i.e. with the formula A/BACT, A being as defined hereinabove,
the sealing layer being welded to the intermediate composite reinforcing layer and the intermediate composite reinforcing layer being welded to the outer composite reinforcing layer.

In another preferred embodiment, the tank according to the invention comprises a multilayer structure, which comprises
only one sealing layer of polyamide 11/10T,
only one intermediate composite reinforcing layer the matrix of which is of polyamide 11/10T and
only one outer composite reinforcing layer, the matrix of which is a copolyamide comprising a 10T unit, i.e. with the formula A/10T, A being as defined hereinabove,
the sealing layer being welded to the intermediate composite reinforcing layer and the intermediate composite reinforcing layer being welded to the outer composite reinforcing layer.

In another preferred embodiment, the tank according to the invention comprises a multilayer structure, which comprises
only one sealing layer of polyamide 11,
only one intermediate composite reinforcing layer the matrix of which is of polyamide 11 and
only one outer composite reinforcing layer, the matrix of which is a copolyamide comprising a 10T unit, i.e. with the formula A/10T, A being as defined hereinabove,
the sealing layer being welded to the intermediate composite reinforcing layer and the intermediate composite reinforcing layer being welded to the outer composite reinforcing layer.

In another preferred embodiment, the tank according to the invention comprises a multilayer structure, which comprises
only one sealing layer of polyamide 11,
only one intermediate composite reinforcing layer the matrix of which is of polyamide 11 and
only one outer composite reinforcing layer, the matrix of which is a copolyamide comprising a 10T unit, i.e. with the formula A/10T, A being as defined hereinabove,
the sealing layer being welded to the intermediate composite reinforcing layer and the intermediate composite reinforcing layer being welded to the outer composite reinforcing layer.

Preferentially, said intermediate composite reinforcing layer preferentially has a thickness comprised between 1 and 10%, even more preferentially comprised between 1 and 5%, relative to the thickness of all the composite reinforcing layers of the multilayer structure.

Advantageously, the multilayer structure of the tank of the invention consists of the three layers defined in the different embodiments described hereinabove.

### As Regards to the Tank

According to one embodiment, the tank according to the invention may comprise the multilayer structure as defined hereinabove and one or a plurality of inserts.

According to another embodiment, the tank according to the invention may comprise the multilayer structure as defined hereinabove and one or a plurality of bases.

According to yet another embodiment, the tank according to the invention may comprise the multilayer structure as defined hereinabove, one or a plurality of inserts and one or a plurality of bases.

“Insert”, as defined by the present invention, refers to parts inserted before or during the deposition of the composite reinforcing layers.

The inserts are intended to be used for the assembly of the tank and of a base.

Inserts can be inserted at the beginning of the tank manufacturing step. In such case, the inserts are constituents of the sealing layer. The insets can e.g. subsequently support the connecting elements of the tanks in the vehicle. Such parts can thereby be directly linked to the initial sealing layer.

Preferentially, the tank comprises one or a plurality of injection-molded inserts made of semi-crystalline, preferentially aliphatic, thermoplastic polymer.

Preferentially, the insert comprises on a majority basis at least one semi-crystalline thermoplastic polyamide, preferentially aliphatic, with a Tf<280° C.

Preferentially, the insert comprises at least one polyamide chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, PA 11/5T, PA 11/6T AND PA11/10T preferentially PA6, PA66, PA410, PA510, PA 69, PA610, PA 512, PA612, PA 514, PA614, PA618, PA PA1010, PA1012, PA1014, PA1018, PA1214, PA1218, PA11 and PA12, preferentially PA 11 or PA12, and mixtures thereof.

Depending on the position of the insert in the structure, the insert is an injected part, made of the same semi-crystalline thermoplastic polyamide as the sealing layer or the aliphatic semi-crystalline thermoplastic polyamide comprised in the intermediate composite reinforcing layer.

According to one embodiment of the tank according to the invention, the tank comprises the multilayer structure as defined hereinabove, one or a plurality of inserts and one or two bases, more particularly metallic and overmolded with a semi-crystalline thermoplastic polyamide, preferentially aliphatic, with Tf<280° C.

When the tank includes a base, the base may be overmolded with a semi-crystalline thermoplastic polyamide, preferentially aliphatic

Preferentially, the polyamide for overmolding the base or bases is chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PAII, PA12, PA 11/5T, PA 11/6T AND PA11/10T preferentially PA6, PA66, PA410, PA510, PA 69, PA610, PA 512, PA612, PA 514, PA614, PA618, PA PA1010, PA1012, PA1014, PA1018, PA1214, PA1218, PA11 and PA12, preferentially PA 11 or PA12, and mixtures thereof.

Preferentially, the material of the insert(s), the material of the layer which overmolds the base(s) and the material comprised in the sealing layer are the same.

In the case where the welding between the base of the tank and the insert or the sealing layer is carried out by induction, then the composition used for overmolding the metal part of the base and/or the composition used for molding the insert comprise ferro-magnetic metal particles.

### The Method

A further subject matter of the present invention is a manufacturing method for a tank as defined hereinabove. The method includes the following successive steps:
at least one step of welding the intermediate composite reinforcing layer onto the sealing layer and
at least one step of welding the outer composite reinforcing layer onto the intermediate composite reinforcement layer.

In one embodiment, the heating of the composite tape(s) prior to welding onto the tank is performed by a system chosen from infrared (IR) heating, LED heating, induction heating or microwave heating or high frequency (HF) heating. The system of positioning said composite tape or tapes in contact with the tank is sufficiently rapid so that the temperature of said tape or tapes remains above the crystallization temperature of the resin forming the matrix of said composite composing said tape, and preferentially 20° C. above the crystallization temperature.

Advantageously, the method consists in depositing the intermediate composite reinforcing layer followed or not by depositing part of the outer composite reinforcing layer, on top of the assembly consisting of the inserts and the sealing layer, then in welding the bases to the inserts, then in finishing the deposition of the outer composite reinforcing [layer].

In another embodiment, the bases may be welded directly to the sealing layer. Then, all the composite layers: intermediate and outer are deposited.

### The Use

Finally, the invention relates to the use of the tank as described hereinabove for the storage of gas under pressure, in particular hydrogen, LPG, CNG, compressed air, e.g. for energy storage.

The examples which follow illustrate the present invention, but are not limited to.

### EXAMPLES

In the following examples, tanks according to the invention and comparative tanks were manufactured. The tanks according to the invention comprise multilayer structures comprising an intermediate composite reinforcing layer. The comparative tanks comprise multilayer structures, which do not comprise any intermediate composite reinforcing layer.

In all the examples, the tanks are manufactured by winding thermoplastic tapes. Thermoplastic tapes are heated by means of IR heating. The thermoplastic tapes are deposited by means of a robot at a speed of 12 m/min.

With regard to the tanks according to the invention, the method consists in winding the tapes around the sealing layer, the tapes being pre-impregnated beforehand with the composition of the intermediate composite reinforcing layer.

Then, a step of winding thermoplastic tape is carried out again, but this time around the intermediate composite reinforcement with tapes pre-impregnated beforehand with the composition of the outer composite reinforcing layer.

### Examples 1 and 2

### Tank Manufacturing

The sealing layer in tanks 1 and 2 was obtained by winding a PA11 film with a melting temperature Tf=190° C. around a metal mandrel. Melting the PA11 film generates the sealing layer in situ. Injection-molded PA11 inserts were also placed on the mandrel, before the deposition of the composite tapes. The bases are overmolded in PA11.

The metal mandrel was removed after the deposition of approximately 1 to 30% of the total thickness of the composite reinforcements. PA11 with a glass transition temperature Tg=50° C. was used to impregnate the carbon fibers of the intermediate composite reinforcing layer. Bases were then welded to the tank blank and the winding of the composite tapes continued until the end of the manufacturing of the final tank. Table 1 below lists the materials of the multilayer structure of the tank.

TABLE 1

| | Ex 1 | Ex 2 |
|---|---|---|
| | Invention | Comparative |
| Sealing layer | PA11 | PA11 |
| Insert | PA11 | PA11 |
| Base overmolding polymer | PA11 | PA11 |
| Intermediate composite layer | PA11 | — |
| | Carbon fibers | |
| Outer composite layer | 11/BACT/10 T | 11/BACT/10 T |
| | (Tg = 140° C.) | (Tg = 140° C.) |
| | carbon fibers | carbon fibers |
| Deformation of inserts | Acceptable | Unacceptable |
| (out-of-roundness, deformation | | |
| of the sealing surface) | | |
| Quality of the base over | Good | Poor |
| insert welding | | |
| Delamination in the composite | No | Yes |
| reinforcement layers | | |

Other materials of the outer layer were tested to produce the tanks according to the invention. Table 2 below shows the materials tested for the composition which impregnates the carbon fibers of the outer composite reinforcing layer.

TABLE 2

| Ex | PA of the outer layer | Tg (° C. |
|---|---|---|
| 11 | PA 11/6 T/10 T | 115 |
| 12 | 11/MPMDT/10 T | 125 |
| 13 | MXDT/10 T | 130 |
| 14 | 11/BACT/10 T | 160 |
| 15 | BACT/10 T | 140 |
| 16 | BACT/10 T | 160 |
| 17 | 11/BACT/6 T | 160 |
| 18 | MPMDT/10 T | 125 |
| 19 | MXDT/6 T | 150 |

A plurality of layer thicknesses of the intermediate composite reinforcing layer were tested: 1, 3, 5, 10, 15 and 30% relative to the total composite reinforcing layers of the structure.

### Evaluation of the Tanks

The tanks were evaluated visually. It has been observed if the inserts were deformed, and in particular if there was deformation of the sealing surface and an out-of-roundness of the inserts.

The quality of the welds between the bases and the inserts was also observed. If the quality seems good enough after a visual inspection, the quality of the welds of the bases on the inserts is tested by pressurizing the tank blank, at 4 bars, for 12 hours. If the weld leaks before the end of such period, the weld is of poor quality. Otherwise, the weld is considered to be good.

The results are shown in Table 1.

### Examples 3 and 4

The manufacturing method followed for examples 1 and 2 was followed to carry out examples 3 and 4.

TABLE 3

| | Ex 3 | Ex 4 |
|---|---|---|
| | Invention | Comparative |
| Sealing layer | PA6 | PA6 |
| Insert | PA6 | PA6 |
| Base overmolding polymer | PA6 | PA6 |
| Intermediate composite layer | PA6 | — |
| | Carbon fibers | |
| Outer composite layer | 11/BACT/10 T | 11/BACT/10 T |
| | (Tg = 140° C.) | (Tg = 140° C.) |
| | carbon fibers | carbon fibers |
| Deformation of inserts | Acceptable | Unacceptable |
| (out-of-roundness, deformation | | |
| of the sealing surface) | | |
| Quality of the base over | Good | Poor |
| insert welding | | |
| Delamination in the composite | No | Yes |
| reinforcement layers | | |

Different materials of the outer layer were tested to produce the tanks according to the invention. Table 4 below shows the materials tested for the composition which impregnates the carbon fibers of the outer composite reinforcing layer.

TABLE 4

| Ex | PA of the outer layer | Tg (° C. |
|---|---|---|
| 31 | PA 11/6 T/10 T | 115 |
| 32 | 11/MPMDT/10 T | 125 |
| 33 | MXDT/10 T | 130 |
| 34 | 11/BACT/10 T | 160 |
| 35 | BACT/10 T | 140 |
| 36 | BACT/10 T | 160 |
| 37 | 11/BACT/6 T | 160 |
| 38 | MPMDT/10 T | 125 |
| 39 | MXDT/6 T | 150 |

A plurality of layer thicknesses of the intermediate composite reinforcing layer were tested: 1, 3, 5, 10, 15 and 30% relative to the total composite reinforcing layers 5 of the structure.

### Examples 5 and 6

The manufacturing method followed for examples 1 and 2 was followed to carry out examples 5 and 6.

TABLE 5

| | Ex 5 | Ex 6 |
|---|---|---|
| | Invention | Comparative |
| Sealing layer | PA66 | PA66 |
| Insert | PA66 | PA66 |
| Base overmolding polymer | PA66 | PA66 |
| Intermediate composite layer | PA66 | — |
| | Carbon fibers | |
| Outer composite layer | 11/BACT/10 T | 11/BACT/10 T |
| | (Tg = 140° C.) | (Tg = 140° C.) |
| | carbon fibers | carbon fibers |
| Deformation of inserts | Acceptable | Unacceptable |
| (out-of-roundness, deformation | | |
| of the sealing surface) | | |
| Quality of the base over | Good | Poor |
| insert welding | | |
| Delamination in the composite | No | Yes |
| reinforcement layers | | |

Different materials of the outer layer were tested to produce the tanks according to the invention. Table 6 below shows the materials tested for the composition which impregnates the carbon fibers of the outer composite reinforcing layer.

TABLE 6

| Ex | PA of the outer layer | Tg (° C. |
|---|---|---|
| 51 | PA 11/6 T/10 T | 115 |
| 52 | 11/MPMDT/10 T | 125 |
| 53 | MXDT/10 T | 130 |
| 54 | 11/BACT/10 T | 160 |
| 55 | BACT/10 T | 140 |
| 56 | BACT/10 T | 160 |
| 57 | 11/BACT/6 T | 160 |
| 58 | MPMDT/10 T | 125 |
| 59 | MXDT/6 T | 150 |

A plurality of layer thicknesses of the intermediate composite reinforcing layer were tested: 1, 3, 5, 10, 15 and 30% relative to the total composite reinforcing layers of the structure.

### Example 7

The sealing layer in the tank of example 7 was obtained by rotational molding. The tank of example 7 does not have an insert.

The tank was evaluated visually after a cutting into 2 parts. The quality of the weld of the intermediate composite layer over the sealing layer was evaluated, as well as the quality of the weld of the composite layers to each other by observing the cross-section of the tank. If the visual inspection leads to finding delaminations in the thickness of the tank, it is concluded that the weld of the tapes over the sealing layer or of the tapes to each other, is poor.

| | Ex 7 Invention |
|---|---|
| Sealing layer | PA11 |
| Intermediate composite layer | PA11 Carbon fibers |
| Outer composite layer | 11/BACT/10 T |
| | (Tg = 140° C.) |
| | carbon fibers |
| Delamination in the composite | No |
| reinforcement layers | |
| Quality of the sealing layer welded | Good |
| onto the intermediate composite layer | |

The results of all these examples show the advantages associated with the presence of the intermediate layer in the structure of the tank.

1. A tank comprising a multilayer structure, for the storage of compressed gas, comprising at least the following three successive layers, from the inside to the outside:
at least one sealing layer consisting of a composition comprising on a majority basis at least one semi-crystalline thermoplastic polyamide, having a melting temperature (Tf), measured according to the standard ISO 11357-3:2013, less than or equal to 280° C.,
at least one intermediate composite reinforcing layer consisting of a fibrous material in the form of continuous fibers impregnated with a composition comprising on a majority basis at least one semi-crystalline thermoplastic polyamide, having a glass transition temperature (Tg) measured according to the standard ISO 11357-3:2013, less than 100° C.,
at least one outer composite reinforcing layer consisting of a fibrous material in the form of continuous fibers impregnated with a composition comprising on a majority basis at least one polyphthalamide having a glass transition temperature (Tg), measured according to the standard ISO standard 11357-3 2013, higher than 80° C.,
the outermost sealing layer being welded to the innermost intermediate composite reinforcing layer, and
the outermost intermediate composite reinforcing layer being welded to the innermost outer composite reinforcing layer.

2. The tank according to claim 1, wherein the semi-crystalline thermoplastic polyamide comprised in the sealing layer has a C/N ratio greater than or equal to 5.

3. The tank according to claim 1, wherein the semi-crystalline thermoplastic polyamide comprised in the sealing layer is chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, PA 11/5T, PA 11/6T AND PA11/10T, and mixtures thereof.

4. The tank according to claim 1, wherein the semi-crystalline thermoplastic polyamide comprised in the sealing layer is an aliphatic polyamide.

5. The tank according to claim 1, wherein the semi-crystalline thermoplastic polyamide impregnating the continuous fibers of the intermediate composite reinforcing layer is chosen from PA410, PA 56, PA59, PA510, PA512, PA513, PA 514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, PA 11/5T, PA 11/6T AND PA11/10T, and mixtures thereof.

6. The tank according to claim 1, wherein the semi-crystalline thermoplastic polyamide impregnating the continuous fibers of the intermediate composite reinforcing layer is an aliphatic polyamide.

7. The tank according to claim 1, wherein the semi-crystalline thermoplastic polyamide impregnating the continuous fibers of the composite outer reinforcing layer is chosen from PA MPMDT/6T, PA 11/10T, PA 11/BACT, PA 5T/10T, PA 11/6T/10T, PA MXDT/4T PA, MXDT/6T PA, MXDT/10T PA, MPMDT/4T PA, MPMDT/6T PA, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T, and mixture thereof.

8. The tank according to claim 1, wherein the intermediate composite reinforcing layer has a thickness comprised between 1 and 30%, with respect to the total thickness of the composite reinforcing layers of the structure.

9. The tank according to claim 1, wherein the fibrous material present in the intermediate composite reinforcing layer and in the outer composite reinforcing layer is chosen from glass fibers, carbon fibers, basalt fibers or contains basalt.

10. The tank according to claim 1, wherein the tank comprises one or a plurality of injection-molded inserts of semi-crystalline thermoplastic polymer.

11. A method of manufacturing the tank as defined in claim 1, wherein the method comprises the following successive steps:
at least one step of welding the intermediate composite reinforcing layer over the sealing layer and
at least one step of welding the outer composite reinforcing layer over the intermediate composite reinforcing layer.

12. A method of storing gases under pressure, the method comprising using the tank as defined in claim 1 for storing gases under pressure.
